(19) United States
(12) Patent Application Publication
(10) Pub. No.: US 2017/0153843 A1
(43) Pub. Date: Jun. 1, 2017

(54) MONITORING AND MANAGING ELASTIC DATA STORAGE DEVICES

(71) Applicant: Western Digital Technologies, Inc., Irvine, CA (US)

(72) Inventors: Dylan Mark Dewitt, Rochester, MN (US); Adam Espeseth, Rochester, MN (US); Ashish Singhai, Los Altos, CA (US); Sanjay Subbarao, Irvine, CA (US)

(21) Appl. No.: 15/054,700

(22) Filed: Feb. 26, 2016

Related U.S. Application Data
(60) Provisional application No. 62/260,420, filed on Nov. 27, 2015.

(51) Int. Cl. G06F 3/06

(52) U.S. Cl. CPC G06F 3/0644; G06F 3/0604; G06F 3/0631; G06F 3/0653; G06F 3/0679

(57) ABSTRACT

In general, techniques of this disclosure describe usage monitoring of data partitions within a data storage device, such as a data storage device that implements elastic capacity. Techniques may be performed by a host device and a controller of a storage device, where the host device causes the controller to perform the techniques described herein. In general, the controller may create a data partition in the data storage device based on a maximum exposed logical size for the data partition, a maximum allocated logical capacity for the data partition, and an allocated physical capacity for the data partition. The controller may write one or more blocks of data to the data partition. The controller may also send an indication representative of physical space used in the data partition to a host device based on the written one or more blocks of data.

This application claims the benefit of U.S. Provisional Application No. 62/260,420 filed Nov. 27, 2015, which is incorporated herein by reference in its entirety.

### TECHNICAL FIELD

The disclosure relates to data storage on storage devices.

### BACKGROUND

Elastic Capacity (EC) on a storage device (e.g. SSD or HDD) utilizes compression to provide a larger logical block (LBA) space to the host than would otherwise be available. Internal to the storage device, write data from the host is compressed. The compressed data occupies the same or less space on the storage medium than uncompressed data. On an SSD, compression can benefit the host in the form of a transparent increase in performance and endurance, or in the case of elastic capacity, additional LBA space.

### SUMMARY

In one example, the disclosure is directed to a method comprising causing, by a host device, a controller of a data storage device to create a data partition in the data storage device based on a maximum exposed logical size for the data partition, a maximum allocated logical capacity for the data partition, and an allocated physical capacity for the data partition; causing, by the host device, the controller to write one or more blocks of data to the data partition; and receiving, by the host device, from the controller, an indication representative of physical space used in the data partition based on the written one or more blocks of data.

In another example, the disclosure is directed to a host device comprising one or more processors configured to cause a controller of a data storage device to create a data partition in the data storage device based on a maximum exposed logical size for the data partition, a maximum allocated logical capacity for the data partition, and an allocated physical capacity for the data partition; cause the controller to write one or more blocks of data to the data partition; and receive, from the controller, an indication representative of physical space used in the data partition based on the written one or more blocks of data.

In another example, the disclosure is directed to an apparatus comprising means for causing a controller of a data storage device to create a data partition in the data storage device based on a maximum exposed logical size for the data partition, a maximum allocated logical capacity for the data partition, and an allocated physical capacity for the data partition; means for causing the controller to write one or more blocks of data to the data partition; and means for receiving, from the controller, an indication representative of physical space used in the data partition based on the written one or more blocks of data.

In another example, the disclosure is directed to a computer-readable storage medium encoded with instructions that, when executed, cause one or more processors to create a data partition in the data storage device based on a maximum exposed logical size for the data partition, a maximum allocated logical capacity for the data partition, and an allocated physical capacity for the data partition; cause the controller to write one or more blocks of data to the data partition; and receive, from the controller, an indication representative of physical space used in the data partition based on the written one or more blocks of data.

In another example, the disclosure is directed to a method comprising creating, by a controller of a storage device, a data partition in the data storage device based on a maximum exposed logical size for the data partition, a maximum allocated logical capacity for the data partition, and an allocated physical capacity for the data partition; writing, by the controller, one or more blocks of data to the data partition; and sending, by the controller, an indication representative of physical space used in the data partition to a host device based on the written one or more blocks of data.

In another example, the disclosure is directed to storage device comprising a controller configured to create a data partition in the data storage device based on a maximum exposed logical size for the data partition, a maximum allocated logical capacity for the data partition, and an allocated physical capacity for the data partition; write one or more blocks of data to the data partition; and send an indication representative of physical space used in the data partition to a host device based on the written one or more blocks of data.

In another example, the disclosure is directed to an apparatus comprising means for creating a data partition in a data storage device based on a maximum exposed logical size for the data partition, a maximum allocated logical capacity for the data partition, and an allocated physical capacity for the data partition; means for writing one or more blocks of data to the data partition; and means for sending an indication representative of physical space used in the data partition to a host device based on the written one or more blocks of data.

In another example, the disclosure is directed to a computer-readable storage medium encoded with instructions that, when executed, cause one or more processors to create a data partition in a data storage device based on a maximum exposed logical size for the data partition, a maximum allocated logical capacity for the data partition, and an allocated physical capacity for the data partition; write one or more blocks of data to the data partition; and send an indication representative of physical space used in the data partition to a host device based on the written one or more blocks of data.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual and schematic block diagram illustrating an example storage environment in which a storage device may function as a storage device for a host device, in accordance with one or more techniques of this disclosure.

FIG. 2 is a block diagram illustrating the controller of FIG. 1 in more detail.

FIG. 3 is a conceptual diagram illustrating a resizing operation performed on a data partition as a result of the usage monitoring techniques of this disclosure.

FIG. 4 is a flow diagram illustrating a usage monitoring technique performed by a host device, in accordance with one or more techniques of this disclosure.

FIG. 5 is a flow diagram illustrating a usage monitoring technique performed by a controller of a storage device, in accordance with one or more techniques of this disclosure.

FIG. 6 is a flow diagram illustrating a technique performed by a host device for determining whether one or more blocks of data exceeds the threshold physical size for the data partition, in accordance with one or more techniques of this disclosure.

FIG. 7 is a flow diagram illustrating a technique performed by a controller of a storage device for determining whether one or more blocks of data exceeds the threshold physical size for the data partition, in accordance with one or more techniques of this disclosure.

FIG. 8 is a flow diagram illustrating a technique performed by either a host device or a controller of a storage device for determining whether to resize a data partition, in accordance with one or more techniques of this disclosure.

### DETAILED DESCRIPTION

In general, techniques of this disclosure describe usage monitoring of data partitions within a data storage device, such as a data storage device that implements elastic capacity. In some examples, the data partition may be a namespace in Non-Volatile Memory Express (NVMe) protocol or a logical unit in serial attached SCSI (SAS) protocol. In a data storage device that implements elastic capacity, more logical addresses may be assigned by the controller of the data storage device to a physical data. partition than can be stored to the data partition without compression. By compressing data, the data storage device may utilize less physical data space than otherwise would occur without data compression, and the data storage device may reclaim this excess physical data space by allowing the host device to use additional logical addresses. Because the data compression is handled by the data storage device and logical address size is not deterministically linked to physical space used in the data partition, the host device may not be aware of the amount of physical space remaining in the data partition. In accordance with techniques of this disclosure, the data storage device may be aware of the physical space used in the data partition and may be configured to report the amount of physical space remaining to the host device.

For instance, a host device may issue a request to a controller of the storage device to create a data partition within the storage device. The host device may then cause the controller to write data blocks to the data partition. At a later time, the controller may issue a report back to the host regarding the physical space used (or remaining) in the data partition, either in response to the host polling the controller or as an asynchronous event.

By reporting the indication of the physical space used in the data partition, the host device may determine various characteristics about the data partition, including a usage percentage of the data partition and a compression ratio of the data partition. Using these characteristics, the host device may, in some examples, resize the data partition such that the data partition is of a more appropriate size for the data contained within the data partition. For instance, if the data partition was too large (i.e., the compression ratio was greater than initially assumed), there may be valuable space on the storage device that would remain unused if the data partition is not resized to be smaller. Conversely, if the data partition was too small (i.e., the compression ratio was less than initially assumed), the controller may not be capable of writing the entirety of the data to the data partition unless the data partition is resized to be larger. As such, the controller may issue error messages and not write the entirely of the requested data blocks to the storage device.

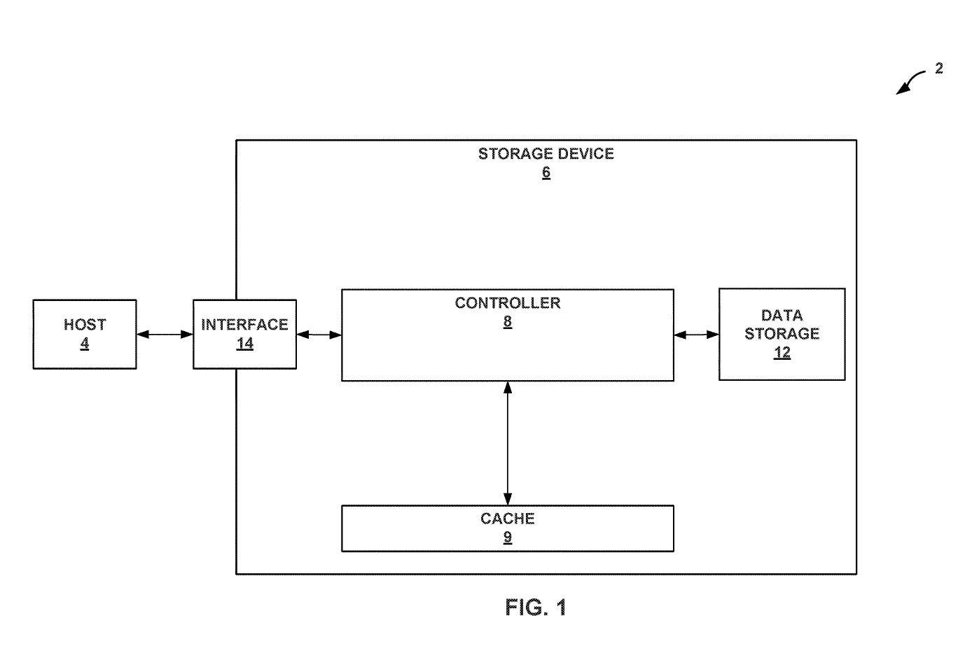

FIG. 1 is a conceptual and schematic block diagram illustrating an example storage environment 2 in which storage device 6 may function as a storage device for host device 4, in accordance with one or more techniques of this disclosure. For instance, host device 4 may utilize non-volatile memory devices included in storage device 6 to store and retrieve data. In some examples, storage environment 2 may include a plurality of storage devices, such as storage device 6, that may operate as a storage array. For instance, storage environment 2 may include a plurality of storages devices 6 configured as a redundant array of inexpensive/independent disks (RAID) that collectively function as a mass storage device for host device 4.

Storage environment 2 may include host device 4 which may store and/or retrieve data to and/or from one or more storage devices, such as storage device 6. As illustrated in FIG. 1, host device 4 may communicate with storage device 6 via interface 14. Host device 4 may comprise any of a wide range of devices, including computer servers, network attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, and the like. Typically, host device 4 comprises any device having a processing unit, which may refer to any form of hardware capable of processing data and may include a general purpose processing unit, such as a central processing unit (CPU), dedicated hardware (such as an application specific integrated circuit (ASIC)), configurable hardware such as a field programmable gate array (FPGA) or any other form of processing unit configured by way of software instructions, microcode, firmware or the like.

As illustrated in FIG. 1 storage device 6 may include a controller 8, a data storage 12, a cache 9, and an interface 14. In some examples, storage device 6 may include additional components not shown in FIG. 1 for ease of illustration purposes. For example, storage device 6 may include power delivery components, including, for example, a capacitor, super capacitor, or battery; a printed board (PB) to which components of storage device 6 are mechanically attached and which includes electrically conductive traces that electrically interconnect components of storage device 6; and the like. In some examples, the physical dimensions and connector configurations of storage device 6 may conform to one or more standard form factors. Some example standard form factors include, but are not limited to, 3.5″ hard disk drive (HDD), 2.5″ HDD, 1.8″ HDD, peripheral component interconnect (PCI), PCI-extended (PCI-X), PCI Express (PCIe) (e.g., PCIe ×1, ×4, ×8, ×16, PCIe Mini Card, MiniPCI, etc.). In some examples, storage device 6 may be directly coupled (e.g., directly soldered) to a motherboard of host device 4.

Storage device 6 may include interface 14 for interfacing with host device 4. Interface 14 may include one or both of a data bus for exchanging data with host device 4 and a control bus for exchanging commands with host device 4. Interface 14 may operate in accordance with any suitable protocol. For example, interface 14 may operate in accordance with one or more of the following protocols: NVMe, advanced technology attachment (ATA) serial-ATA (SATA), and parallel-ATA (PATA)), Fibre Channel small computer system interface (SCSI), serially attached SCSI (SAS), peripheral component interconnect (PCI), and PCI-express (PCIe). The electrical connection of interface 14 (e.g., the data bus, the control bus, or both) is electrically connected to controller 8, providing electrical connection between host device 4 and controller 8, allowing data to be exchanged between host device 4 and controller 8. In sonic examples, the electrical connection of interface 14 may also permit storage device 6 to receive power from host device 4.

Storage device 6 includes controller 8, which may manage one or more operations of storage device 6. Controller 8 may interface with host device 4 via interface 14 and manage the storage of data to and the retrieval of data from data storage 12. In some examples, data storage 12 may include non-volatile data storage devices that are configured to store data even if power is removed from storage device 6. For example, data storage 12 may include a magnetic data storage medium, such as a magnetic data disk. Controller 8 may interface with a hardware engine, which may include a read/write head, to control writing of data to and reading of data from data storage 12 that includes a magnetic data storage medium. As another example, data storage 12 may include solid state memory devices, such as, for example, flash memory devices, phase-change memory (PCM) devices, resistive random-access memory (ReRAM) devices, magnetoresistive random-access memory (MRAM) devices, ferroelectric random-access memory (F-RAM), holographic memory devices, and any other type of non-volatile memory devices.

In accordance with techniques of this disclosure, host device 4 may cause controller 8 of storage device 6 to create a data partition within storage device 6. In some examples, if interface 14 operates under the NVMe protocol, the data partition may be a namespace. In other instances, if interface 14 operates under the SAS protocol, the data partition may be a logical unit. Host device 4 may define the data partition using syntax elements that indicate a maximum exposed logical size for the data partition, a maximum allocated logical capacity for the data partition, and an allocated physical capacity for the data partition. In creating the data partition, host device 4 may assume a baseline compression ratio for all data to be written to the data partition, such as 2:1 or the like.

As an example, storage device 6 may be fully unallocated, with 500 MiB of available physical space and 500 MiB of total space. Further, storage device 6 may have 2,000,000 available LBAs, assuming an average of 2:1 compression for all data stored by storage device 6 and assuming a logical block size of 512 bytes. Host device 4 may create a data partition with a maximum exposed logical size for the data partition of 500,000, a maximum allocated logical capacity for the data partition of 500,000, and an allocated physical capacity for the data partition 128 MiB. These parameters assume an average compression ratio of 2:1. Other parameters, including other compression ratios, also may be used by host device 4.

Host device 4 may further cause controller 8 to write one or more blocks of data to the data partition. The one or more data blocks may be compressible. For instance, the size of the one or more data blocks may be larger than the allocated physical capacity, assuming that some compression may occur on the blocks. In this example (assuming a 2:1 average compression ratio for data stored to the data partition), host device 4 may cause controller 8 to write data blocks with a total size of 256 MiB to storage device 6. Host device 4 may not inherently be aware of the compression ratios that actually occur within storage device 6. As such, host device 4 may require information from storage device 6 (e.g., hardware controller 8) regarding the data partition in order to efficiently manage such elastic data partitions.

Host device 4 may receive, from controller 8, an indication representative of physical space used in the data partition based at least in part on the written one or more blocks of data. Using this indication, host device 4 may determine various characteristics regarding the data partition and the written data. For instance, host device 4 may determine a compression ratio of the data partition based at least in part on the amount of physical space used by the one or more blocks of data and an amount of logical capacity used by the one or more blocks of data (i.e., compression ratio equals the allocated logical capacity multiplied by a number of bytes per logical block address divided by the actual physical space in bytes used in the data partition). In another instance, host device 4 may determine a usage percentage of the data partition based at least in part on the allocated physical capacity and the indication representative of physical space used in the data partition (i.e., usage percentage=the physical space used in the data partition divided by the allocated physical capacity multiplied by 100%).

For instance, if the set of data blocks have a compressed size of 128 MiB (i.e., a compression ratio of 2:1 for data blocks with an uncompressed size of 256 MiB), host device 4 may not resize the data partition at all. However, if the set of data blocks have a compressed size of 170.7 MiB (i.e., a compression ratio of 1.5:1 for data blocks with an uncompressed size of 256 MiB), host device 4 may resize the data partition to increase the allocated physical capacity for the data partition and/or decrease the maximum exposed logical size for the data partition and the maximum allocated logical capacity for the data partition. Conversely, if the set of data blocks have a compressed size of 64 MiB (i.e., a compression ratio of 4:1), host device 4 may resize the data partition to decrease the allocated physical capacity for the data partition and/or increase the maximum exposed logical size for the data partition and the maximum allocated logical capacity for the data partition. By decreasing the allocated physical capacity, controller 8 may release the formerly reserved physical storage space to system 2. Host device 4 may then store other data blocks in that formerly reserved physical storage space. By increasing the maximum exposed logical size for the data partition and the maximum allocated logical capacity for the data partition, controller 8 may write more data to the data partition, freeing space elsewhere in data storage 12.

Techniques of this disclosure define constructs to enable host management of elastic capacity that can be applied to any host interface and storage device that supports compression. These constructs are defined generically and can be integrated into storage host interface standards such as NVMe, SAS, or SATA, or may be kept vendor unique. These constructs may provide host visibility and control of free and used physical space on the storage device's media.

The techniques described herein may further resolve terminology conflicts and ambiguities that arise from mapping elastic capacity constructs into LBA resource provisioning constructs. LBA resource provisioning on a storage device, sometimes termed “Thin Provisioning,” allows the host to manage limited logical block mapping resources on a storage device. In order to map elastic capacity into thin provisioning terminology, the shared terminology may be defined very generically and be ambiguous in interface standards, resulting in incompatible implementations across vendors. Some techniques may also prevent the proper coexistence of thin provisioning and elastic capacity from a host management standpoint. The techniques described herein may overcome the terminology conflicts and ambiguity that other solutions for host management of elastic capacity suffer from.

The NVMe and SAS interface standards provide a management interface for thin provisioning, and sonic proposals for applying elastic capacity to these standards involve extending this interface. The problem with this approach is that it attempts to solve two unrelated problems using a single management interface. Thin provisioning usually refers to management of limited LBA mapping resources. A thinly provisioned storage device may only support a limited quantity of the full set of host-accessible LBAs to be allocated at any given time. The thin provisioning use case may involve presenting a large, sparsely-populated LBA space to the host.

On NVMe, a thinly provisioned namespace may be created by the host by specifying NSZE (namespace size) and NCAP (namespace capacity), along with the LBA block size. NSZE represents the total LBA space accessible by the host, while NCAP represents the maximum number of LBAs which may be allocated at a given time. NVMe defines an LBA being allocated as being written by the host. An LBA can also be deallocated by the host, after which a fixed read data pattern is returned. Deallocated LBAs do not consume resources on the NAND media, and by definition do not consume LBA mapping resources on a thinly provisioned device. In addition to specifying NSZE and NCAP which is a one-time operation, the host may query the Identify Namespace data structure during runtime to read NUSE (namespace use) NUSE communicates the current number of allocated LBAs to the host. By the NVMe definition of LBA allocation, NUSE is deterministic in that it equals the number of allocated LBAs at any given time.

One proposal for mapping elastic capacity into NVMe is for the storage device to calculate and report NUSE such that NUSE/NCAP*100% equals the fullness percentage of that namespace. There are several problems with this approach. First, this violates the NVMe standard definition of NUSE as being strictly equivalent to the number of allocated LBAs. On a write to an LBA which overwrites and invalidates previously written data, NUSE could change due to the new data being more or less compressible than the previous data for that LBA. This causes NUSE to change unexpectedly and nondeterministically. Secondly, this approach prevents the coexistence of thin provisioning and elastic capacity because these two resource management schemes require different thresholds.

The techniques described herein may allow the host to control the amount of physical storage out of unallocated physical storage that may be allocated to a. namespace that supports elastic capacity. In the NVMe protocol, this is accomplished through the introduction of the syntax element NVMUSE, which the controller may define as the number of physical bytes used in a namespace out of the total number of allocated physical space. Other protocols, such as SAS, may use equivalent syntax elements. The techniques described herein may further allow the host to directly query and monitor the physical space usage of the elastic namespace as the drive operates. The techniques described herein may also allow the host to enable asynchronous notifications for physical space fullness. The techniques described herein may provide for the coexistence of elastic capacity and thin provisioning within a single namespace.

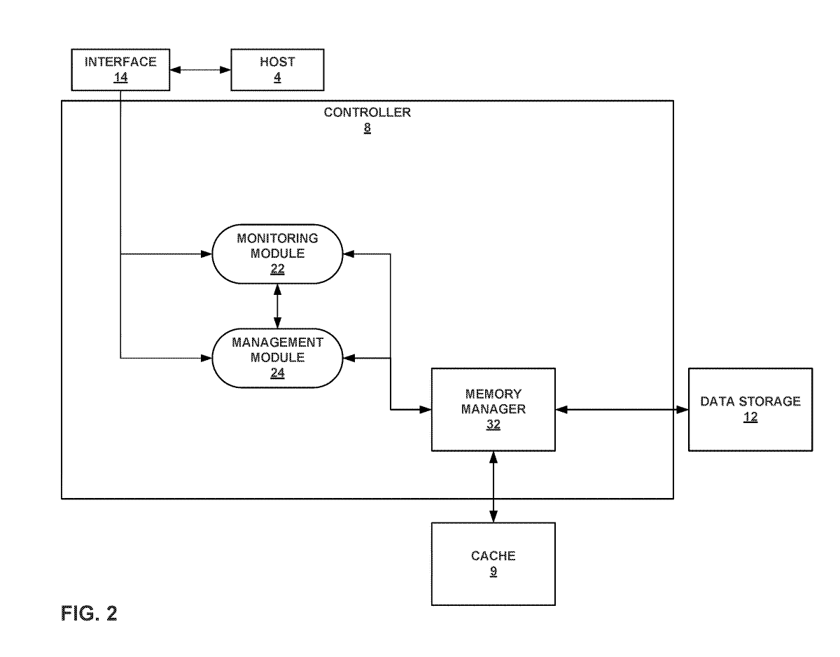

FIG. 2 is a block diagram illustrating controller 8 of FIG. 1 in more detail. In the example of FIG. 2, controller 8 includes interface 14, monitoring module 22, management module 24, and memory manager unit 32. Controller 8 includes various modules, including monitoring module 22 and management module 24. The various modules of controller 8 may be configured to perform various techniques of this disclosure, including the technique described above with respect to FIG. 1. Monitoring module 22 and management module 24 may perform operations described herein using software, hardware, firmware, or a mixture of hardware, software, and firmware residing in and/or executing on storage device 6.

Memory manager unit 32 and hardware engine interface unit 34 may perform various functions typical of a controller on a hard drive. For instance, hardware engine interface unit 34 may represent a unit configured to facilitate communications between the hardware controller 8 and the hardware engine 10. Hardware engine interface unit 34 may present a standardized or uniform way by which to interface with hardware engine 10. Hardware engine interface 34 may provide various configuration data and events to hardware engine 10, which may then process the event in accordance with the configuration data, returning various different types of information depending on the event. In the context of an event requesting that data be read (e.g., a read request), hardware engine 10 may return the data to hardware engine interface 34, which may pass the data to memory manager unit 32. Memory manager unit 32 may store the read data to volatile memory 9 and return a pointer or other indication of where this read data is stored to hardware engine interface 34. In the context of an event involving a request to write data (e.g. a write request), hardware engine 10 may return an indication that the write has completed to hardware engine interface unit 34. In this respect, hardware engine interface unit 34 may provide a protocol and handshake mechanism with which to interface with hardware engine 10.

In accordance with techniques of this disclosure, management module 24 of controller 8 of storage device 6 may create a data partition within storage device 6. In some examples, if interface 14 operates under the NVMe protocol, the data partition may be a namespace. In other instances, if interface 14 operates under the SAS protocol, the data partition may be a logical unit. Management module 24 may define the data partition using syntax elements received from host device 4 that indicate at least a maximum exposed logical size for the data partition, a maximum allocated logical capacity for the data partition, and an allocated physical capacity for the data partition.

Management module 24 of controller 8 may further write one or more blocks of data to the data partition. In some examples, the one or more blocks of data may be compressible. In some examples, in writing the one or more blocks of data to the partition, management module 24 of controller 8 may write at least a portion of the one or more blocks of data to the data partition of storage device 6.

Monitoring module 22 of controller 8 may determine an actual physical space used in the data partition. For instance, monitoring module 22 may determine whether a size of a remaining portion of the one or more blocks of data to be written to the data partition exceeds a threshold physical size for the data partition. If the size of the remaining portion does not exceed the physical threshold, management module 24 of controller 8 may continue to write the remaining portion of the blocks of data to the data partition. Responsive to the size of the remaining portion of the one or more blocks of data exceeding the threshold physical size for the data partition, monitoring module 22 may alert host device 4 that the threshold physical size has been exceeded. In some instances, host device 4 may generate a request to resize the allocated physical capacity the data partition. Monitoring module 22 of controller 8 may receive this request to resize the allocated physical capacity of the data partition issued by controller 8. For instance, the threshold physical size for the data partition may be a difference between the allocated physical capacity of the data partition and an amount of physical space used by the portion of the one or more blocks of data. In other words, monitoring module 22 of controller 8 may, responsive to either commands from host device 4 or an asynchronous event initiated by controller 8 and communicated to host device 4, dynamically check if the data to be written to the data partition will be too large for the data partition based on the currently available physical space. This could occur if the compression ratio is less than the assumed compression ratio, such as 1.5:1 instead of 11. Rather than simply attempt to write all of the one or more data blocks to the data. partition and address errors should they arise, by dynamically checking the available space and comparing the available space with the remaining data to be written, management module 24 of controller 8 may resize the data partition before such errors are realized.

Monitoring module 22 of controller 8 may issue an indication representative of physical space used in the data partition based at least in part on the written one or more blocks of data. Using this indication, monitoring module 22 of controller 8 may determine various characteristics regarding the data partition and the written data. For instance, monitoring module 22 may determine a compression ratio of the data partition based at least in part on the amount of physical space used by the one or more blocks of data and an amount of logical capacity used by the one or more blocks of data compression ratio=the allocated logical capacity multiplied by a number of bytes per logical block address divided by the physical space used in the data partition). In another instance, monitoring module 22 may determine a usage percentage of the data partition based at least in part on the allocated physical capacity and the indication representative of physical space in the data partition (i.e., usage percentage=the physical space used in the data partition divided by the allocated physical capacity multiplied by 100%). Alternatively, monitoring module 22 may communicate one or more pieces of this information to host device 4, and host device 4 may determine the remainder.

Using these compression ratio and usage percentage characteristics, management module 24 of controller 8 may resize portions of the data partition, for example, responsive to requests from host device 4. For instance, host device 4 may cause controller 8 to resize the allocated physical capacity of the data partition based at least in part on the usage percentage and the compression ratio. When the compression ratio is greater than an assumed compression ratio, management module 24 may decrease the allocated physical capacity of the data partition to free room in storage device 6 for other data, as the data stored by the data partition may consume less actual physical space that initially predicted. In other instances, when the compression ratio is less than the assumed compression ratio, management module 24 may increase the physical capacity of the data partition to provide sufficient physical space for storing data to the data partition and reduce errors that may occur from underprovisioning for the data blocks to be stored.

In another example, management module 24 of controller 8 may resize at least one of the maximum exposed logical size or the maximum allocated logical capacity based at least in part on the usage percentage and the compression ratio, for example, in response to a request from host device 4. When the compression ratio is greater than an assumed compression ratio, a larger number of LBAs may be written to the data partition than initially predicted, as, on average, a give LBA consumes a smaller physical space of the data partition when the compression ratio is higher. As such, management module 24 may increase the maximum exposed logical size or the maximum allocated logical capacity to allow for more LBAs to be written into the same physical space. In other instances, when the compression ratio is less than the assumed compression ratio, fewer LBAs may be written to the data partition. As such, management module 24 may decrease the maximum exposed logical size or the maximum allocated logical capacity to allow for the limited number of LBAs to be used in other data partitions.

As described above, one example of a data partition may be a namespace when the techniques described herein are used according to the NVMe protocol. However, techniques of this disclosure may also be used according to the SAS protocol, wherein the data partition is a logical unit. Although the example provided below described terminology with respect to the NVMe protocol, the techniques described herein may be used for any protocol that may utilize elastic storage and compressed data management as descried herein, such as the SAS protocol.

Namespaces, as discussed herein, are unique to NVMe, but analogous constructs exist on other interfaces. The key capability provided by namespaces is to allocate separate LBA spaces with unique block sizes out of the larger global storage space. On SAS, separate logical units could be created and managed in a vendor unique fashion to serve the same purpose.

In one example implementation according to NVMe, the following syntax elements are utilized:

MaxLogicalCapacity (NVMe: TCAP): the total drive capacity in LBAs on data storage 12. MaxPhysicalCapacity (NVMe: TNVMCAP): the total physical media capacity in bytes on data storage 12. UnallocatedPhysicalCapacity (NVMe: UNVMCAP): the unallocated physical space not currently assigned to any namespace on data storage 12. UNVMCAP is defined by NVMe as a field in Identify data. NamespaceAddressSize (NVMe: NSZE): Maximum exposed logical size (LBA range) of a namespace on data storage 12. NamespaceMaxLogicalCapacity (NVMe: NCAP): Maximum allocated logical capacity of a namespace on data storage 12. NamespaceLogicalCapacityUsage (NVMe: NUSE): Allocated logical capacity used of a namespace on data storage 12. NamespaceMaxPhysicalCapacity (NVMe: NVMCAP): The physical capacity (e.g., in bytes) that is allocated to a namespace on data storage 12. NVMCAP is defined in this manner in NVMe, but it is not specified on namespace create per the NVMe spec. In some examples, NVMCAP may be provided as a namespace create parameter. This may allow the host to specify and directly control the number of bytes out of free physical space (UNVMCAP) that are allocated to a namespace. If NVMCAP=0 or is not specified on NamespaceCreate( ), NVMCAP is calculated by the storage controller and reported as defined by NVMe. In this scenario, elastic capacity capabilities may be disabled for the namespace. NamespacePhysicalCapacityUsage (NVMe: NVMUSE−New field): Represents the number of physical bytes used in the namespace out of NVMCAP (total). NVMUSE may use the same units as NVMCAP.

NVMCAP, TNVMCAP, and UNVMCAP may not be strictly physical such that they may include overprovisioned space or spare blocks. These parameters may simply be block size-independent metrics of physical space that scale linearly with available logical blocks. Note that this usage and definition of these parameters may be more constrained than what is defined by NVMe, which leaves the definitions vendor unique. This more strict set of definitions may make these parameters useful for host management of elastic capacity. These parameters may be scaled such that the host can divide them by 512 to calculate LBA units.

Interface 14 may provide a method for the host to configure a threshold for an asynchronous notification that is triggered at a specified NVMUSE threshold and reporting interval. Polling may also be used by host 4. The NVMe async event “Namespace Attribute Changed” could be used for this purpose. This may be a “notice” type rather than an error condition event, and may be cleared by reading the Identify Namespace data structure.

Host 4 may check for fullness using NVMUSE/NVMCAP*100%. This may be a useful parameter with threshold for the asynchronous event notification. Host 4 may calculate the running compression ratio using MUSE*512/NVMUSE. Host 4 may use TCAP to calculate the remaining LBA mapping resources.

In some examples, TCAP may equal the International Disk Drive Equipment and Materials Association (IDEMA) number of LBAs*2. Further, the Maximum NSIZE may equal NCAP, which may equal 1.6 TB for any namespace. Error correction (EC) may be applied to each namespace independently, with different targeted compression ratios in each EC. In some examples, namespaces may have an NSZE that equals the NCAP, which indicates that thin provisioning is not supported by the namespace. Namespaces may be resized dynamically using a vendor unique (VU) command. For instance, NVMCAP can be increased or decreased, such that NVMCAP is greater than or equal to NVMUSE. NSZE and NCAP may also be increased or decreased, and can trigger automatic deallocation if decreased.

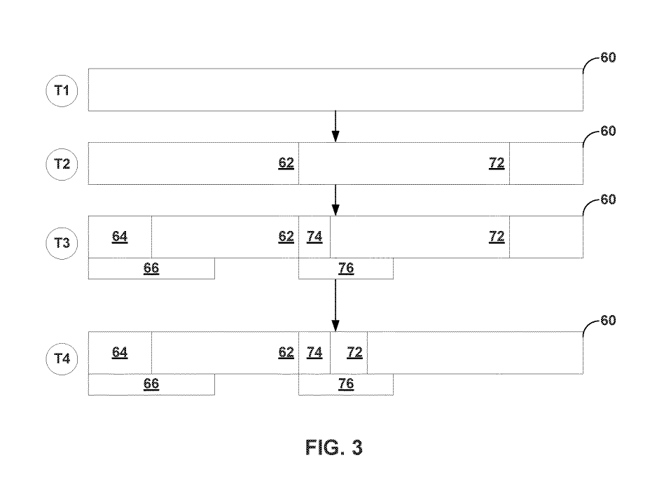

FIG. 3 is a conceptual diagram illustrating a resizing operation performed on a data partition as a result of the usage monitoring techniques of this disclosure. For the purposes of illustration only, reference will be made to structures of FIG. 1 in describing the functionality performed in accordance with the techniques of this disclosure. In this example, at time T1, a storage device includes a memory 60. In this example, memory 60 may have 1 GB of total physical storage, 1 GB of available physical storage, and 4,000,000 total LBA capacity, although other examples of memory 60 may have any size suitable for performing the techniques described herein.

At time T2, host device 4 may cause controller 8 to create two data partitions 62 and 72. For instance, data partition 62 may he instantiated with a maximum exposed logical size for the data partition of 500,000, a maximum allocated logical capacity for the data partition of 500,000, and an allocated physical capacity for the data partition of 128 MiB. Data partition 72 may be instantiated with a maximum exposed logical size for the data partition of 750,000, a maximum allocated logical capacity for the data partition of 750,000, and an allocated physical capacity for the data partition of 192 MiB. Each of data partitions 62 and 72 may be created with an assumed compression ratio of 2:1.

At time T3, host device 4 may cause controller 8 to write data blocks 64 and 74 to data partitions 62 and 72, respectively. Each of data blocks 64 and 74 may be associated with a respective set of LBAs 66 and 76. In the example of FIG. 3, data blocks 64 may be compressed to have an actual physical space of 32 MiB and have 125,000 LBAs in LBA set 66. Further, data blocks 74 may be compressed to have an actual physical space of 16 MiB and have 93,750 LBAs in LBA set 76. After compressing the data blocks and writing the compressed data to memory 60, controller 8 may report indications of the physical space used by data blocks 64 and 74 in the respective data partitions 62 and 72.

At time T4, host device 4 (or, in some automated examples, controller 8) may determine characteristics of each of data partitions 62 and 72 and resize data partitions 62 and 72 as necessary. For instance, host device 4 may determine a usage percentage of data partition 62 based at least in part on the allocated physical capacity and the indication representative of physical space in data partition 62 after writing data blocks 64. Host device 4 may also determine a compression ratio of data partition 62 based at least in part on the amount of physical space used by data blocks 64 and an amount of logical capacity used by LBAs 66. In the example of FIG. 3, using the equation usage percentage=the physical space used in the data partition divided by the allocated physical capacity multiplied by 100%, host device 4 may determine the usage percentage of data partition 62 to be 25% Further, using the equation compression ratio=the allocated logical capacity multiplied by a number of bytes per logical block address divided by the physical space used in the data partition, host device 4 may determine the compression ratio of data partition 62 to be 2:1. Since this compression ratio is equal to the assumed compression ratio upon creation of data partition 62, host device 4 may not resize data partition 62. In other examples, when data partition 62 is not expected to contain any more data, host device 4 may cause controller 8 to resize each of the maximum exposed logical size for data partition 62, the maximum allocated logical capacity for data partition 62, and the allocated physical capacity for data partition 62 by a factor of 25%, or the usage percentage.

Also at time T4, host device 4 may determine characteristics of data partition 72 and resize data partition 72 as necessary. For instance, host device 4 may determine a usage percentage of data partition 72 based at least in part on the allocated physical capacity and the indication representative of physical space in data partition 72 after writing data blocks 74. Host device 4 may also determine a compression ratio of data partition 72 based at least in part on the amount of physical space used by data blocks 74 and an amount of logical capacity used by LBAs 76. In the example of FIG. 3, using the equation usage percentage=the physical space used in the data partition divided by the allocated physical capacity multiplied by 100%, host device 4 may determine the usage percentage of data partition 72 to be 8.3%. Further, using the equation compression ratio=the allocated logical capacity multiplied by a number of bytes per logical block address divided by the physical space used in the data partition, host device 4 may determine the compression ratio of data partition 72 to be 3:1.

Since this compression ratio is greater than to the assumed compression ratio upon creation of data partition 72, host device 4 may cause controller 8 to resize data partition 72 accordingly. For example, controller 8 may resize data partition 72 such that it holds the same number of LBAs, but adjusting the physical capacity. In the example of FIG. 3, resizing data partition 72 as such may lead to controller 8 resizing the allocated physical capacity for data partition 72 to equal 128 MiB. In other instances, controller 8 may resize data partition 72 such that data partition 72 holds the same physical space in memory 60. In the example of FIG. 3, resizing data partition 72 as such may lead to controller 8 resizing the maximum exposed logical size for data partition 72 and the maximum allocated logical capacity for data partition 72 to each equal 1,125,000.

In some instances, when data partition 72 is not expected to contain any more data, host device 4 may cause controller 8 to further resize each of the maximum exposed logical size for data partition 72, the maximum allocated logical capacity for data partition 72, and the allocated physical capacity for data partition 72 by a factor of the usage percentage determined after any resizes computed above (either 8.3% if the total physical capacity is not resized, or 12.5% if the total physical capacity is resized).

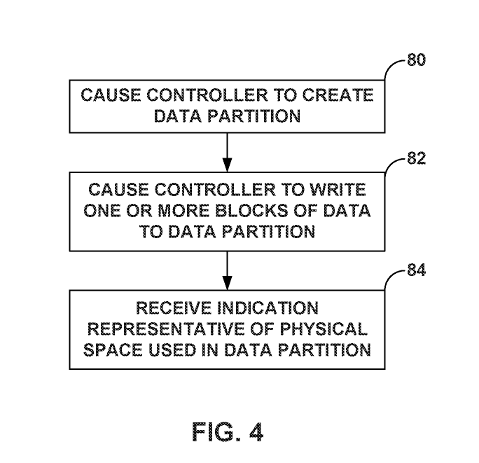

FIG. 4 is a flow diagram illustrating a usage monitoring technique performed by a host device, in accordance with one or more techniques of this disclosure. For the purposes of illustration only, reference will be made to structures of FIG. 1 in describing the functionality performed in accordance with the techniques of this disclosure.

In accordance with techniques of this disclosure, host device 4 may cause controller 8 of storage device 6 to create a data partition within storage device 6 (80). In some examples, if interface 14 operates under the NVMe protocol, the data partition may be a namespace. In other instances, if interface 14 operates under the SAS protocol, the data partition may be a logical unit. Host device 4 may define the data partition using syntax elements that indicate a maximum exposed logical size for the data partition, a maximum allocated logical capacity for the data partition, and an allocated physical capacity for the data partition. In creating the data partition, host device 4 may assume a baseline compression ratio for all data to be written to the data partition, such as 2:1.

Host device 4 may further cause controller 8 to write one or more blocks of data to the data partition (82). In some examples, the one or more blocks of data may be compressible. In some examples, in causing controller 8 to write the one or more blocks of data to the partition, host device 4 may cause controller 8 to write at least a portion of the one or more blocks of data to the data partition of storage device 6.

Host device 4 may receive, from controller 8, an indication representative of physical space used in the data partition based at least in part on the written one or more blocks of data (84). Using this indication, host device 4 may optionally determine various characteristics regarding the data partition and the written data. For instance, host device 4 may determine a compression ratio of the data partition based at least in part on the amount of physical space used by the one or more blocks of data and an amount of logical capacity used by the one or more blocks of data (i.e., compression ratio=the allocated logical capacity multiplied by a number of bytes per logical block address divided by the physical space used in the data partition). In another instance, host device 4 may determine a usage percentage of the data partition based at least in part on the allocated physical capacity and the indication representative of physical space in the data partition (i.e., usage percentage=the physical space used in the data partition divided by the allocated physical capacity multiplied by 100%).

Host device 4 may then cause the controller to determine whether a size of a remaining portion of the one or more blocks of data to be written to the data partition exceeds a threshold physical size for the data partition. If the size of the remaining portion does not exceed the physical threshold, controller 8 may continue to write the remaining portion of the blocks of data to the data partition. Responsive to the size of the remaining portion of the one or more blocks of data exceeding the threshold physical size for the data partition, host device 4 may receive a request to resize the allocated physical capacity of the data partition issued by controller 8. For instance, the threshold physical size for the data partition may be a difference between the allocated. physical capacity of the data partition and an amount of physical space used by the portion of the one or more blocks of data. In other words, host device 4 may dynamically check if the data to be written to the data partition will be too large for the data partition based on the currently available physical space. This could occur if the compression ratio is less than the assumed compression ratio, such as 1.5:1 instead of 2:1. Rather than simply attempt to write all of the one or more data blocks to the data partition and deal with errors should they arise, by dynamically checking the available space and comparing the available space with the remaining data to be written, host device 4 may issue orders to resize the data partition before such errors are realized.

Using these compression ratio and usage percentage characteristics, host device 4 may issue orders to controller 8 to resize portions of the data partition. For instance, host device 4 may cause controller 8 to resize the allocated physical capacity of the data partition based at least in part on the usage percentage and the compression ratio. When the compression ratio is greater than an assumed compression ratio, host device 4 may decrease the allocated physical capacity of the data partition to free room in storage device 6 for other data. In other instances, when the compression ratio is less than the assumed compression ratio, host device 4 may increase the physical capacity of the data partition to decrease any errors that may occur from underprovisioning for the data blocks.

In another example, host device 4 may cause controller 8 to resize at least one of the maximum exposed logical size or the maximum allocated logical capacity based at least in part on the usage percentage and the compression ratio. When the compression ratio is greater than an assumed compression ratio, a larger number of LBAs may be written to the data partition. As such, host device 4 may increase the maximum exposed logical size or the maximum allocated logical capacity to allow for more LBAs to be written into the same physical space. In other instances, when the compression ratio is less than the assumed compression ratio, fewer LBAs may be written to the data partition. As such, host device 4 may decrease the maximum exposed logical size or the maximum allocated logical capacity to allow for the limited number of LBAs to be used in other data partitions.

In some examples, host device 4 may determine a threshold physical capacity based on the allocated physical capacity for the data partition, such as 90% of the total allocated physical capacity, or the like. In such examples, host device 4 may then determine, based on the indication representative of physical space used in the data partition, that the physical space used in the data partition exceeds the threshold physical capacity. When the physical space used exceeds the threshold physical capacity, host device 4 may issue a request to resize the allocated physical capacity of the data partition to controller 8, may cease issuing write commands to controller 8 for the data partition, or the like.

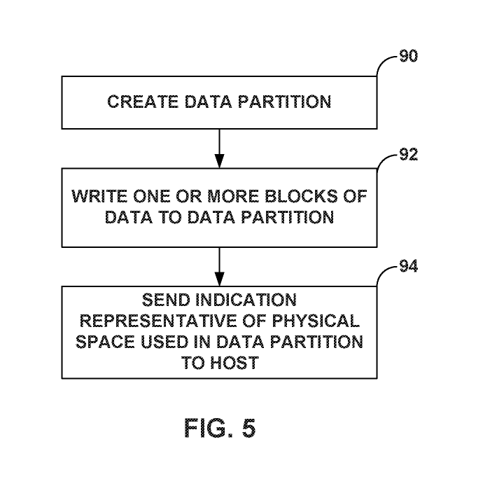

FIG. 5 is a flow diagram illustrating a usage monitoring technique performed by a controller of a storage device, in accordance with one or more techniques of this disclosure. For the purposes of illustration only, reference will be made to structures of FIG. 1 in describing the functionality performed in accordance with the techniques of this disclosure.

In accordance with techniques of this disclosure, controller 8 of storage device 6 may create a data partition within storage device 6 (90). In some examples, if interface 14 operates under the NVMe protocol, the data partition may be a namespace. In other instances, if interface 14 operates under the SAS protocol, the data partition may be a logical unit. Controller 8 may define the data partition using syntax elements received from host device 4 that indicate a maximum exposed logical size for the data partition, a maximum allocated logical capacity for the data partition, and an allocated physical capacity for the data partition.

Controller 8 may further write one or more blocks of data to the data partition (92). In some examples, the one or more blocks of data may be compressible. In some examples, in writing the one or more blocks of data to the partition, controller 8 may write at least a portion of the one or more blocks of data to the data partition of storage device 6. Controller 8 may then determine whether a size of a remaining portion of the one or more blocks of data to be written to the data partition exceeds a threshold physical size for the data partition the size of the remaining portion does not exceed the physical threshold, controller 8 may continue to write the remaining portion of the blocks of data to the data partition. Responsive to the size of the remaining portion of the one or more blocks of data exceeding the threshold physical size for the data partition, controller 8 may issue a request to resize the allocated physical capacity of the data partition to host device 4. For instance, the threshold physical size for the data partition may be a difference between the allocated physical capacity of the data partition and an amount of physical space used by the portion of the one or more blocks of data. In other words, controller 8 may, responsive to commands from host device 4, dynamically check if the data to be written to the data partition will be too large for the data partition based on the currently available physical space. This could occur if the compression ratio is less than the assumed compression ratio, such as 1:5:1 instead of 2:1. Rather than simply attempt to write all of the one or more data blocks to the data partition and deal with errors should they arise, by dynamically checking the available space and comparing the available space with the remaining data to be written, controller 8 may resize the data partition before such errors are realized.

Controller 8 may issue an indication representative of physical space used in the data partition based at least in part on the written one or more blocks of data (94). Using this indication, controller 8 may determine various characteristics regarding the data partition and the written data. For instance, controller 8 may determine a compression ratio of the data partition based at least in part on the amount of physical space used by the one or more blocks of data and an amount of logical capacity used by the one or more blocks of data (i.e., compression ratio=the allocated logical capacity multiplied by a number of bytes per logical block address divided by the physical space used in the data partition). In another instance, controller 8 may determine a usage percentage of the data partition based at least in part on the allocated physical capacity and the indication representative of physical space in the data partition (i.e., usage percentage=the physical space used in the data partition divided by the allocated physical capacity multiplied by 100%).

Using these compression ratio and usage percentage characteristics, controller 8 may resize portions of the data partition, possibly responsive to requests from host device 4. For instance, host device 4 may cause controller 8 to resize the allocated physical capacity of the data partition based at least in part on the usage percentage and the compression ratio. When the compression ratio is greater than an assumed compression ratio, controller 8 may decrease the allocated physical capacity of the data partition to free room in storage device 6 for other data. In other instances, when the compression ratio is less than the assumed compression ratio, controller 8 may increase the physical capacity of the data partition to decrease any errors that may occur from underprovisioning for the data blocks.

In another example, controller 8 may resize at least one of the maximum exposed logical size or the maximum allocated logical capacity based at least in part on the usage percentage and the compression ratio. When the compression ratio is greater than an assumed compression ratio, a larger number of LBAs may be written to the data partition. As such, controller 8 may increase the maximum exposed logical size or the maximum allocated logical capacity to allow for more LBAs to be written into the same physical space. In other instances, when the compression ratio is less than the assumed compression ratio, fewer LBAs may be written to the data partition. As such, controller 8 may decrease the maximum exposed logical size or the maximum allocated logical capacity to allow for the limited number of LBAs to be used in other data partitions.

In some examples, controller 8 may determine a threshold physical capacity based on the allocated physical capacity for the data partition, such as 90% of the total allocated physical capacity, or the like. In such examples, controller 8 may then determine, based on the indication representative of physical space used in the data partition, that the physical space used in the data partition exceeds the threshold physical capacity. When the physical space used exceeds the threshold physical capacity, controller 8 may issue a request to resize the allocated physical capacity of the data partition to host device 4, may cease issuing write commands to controller 8 for the data partition, or the like.

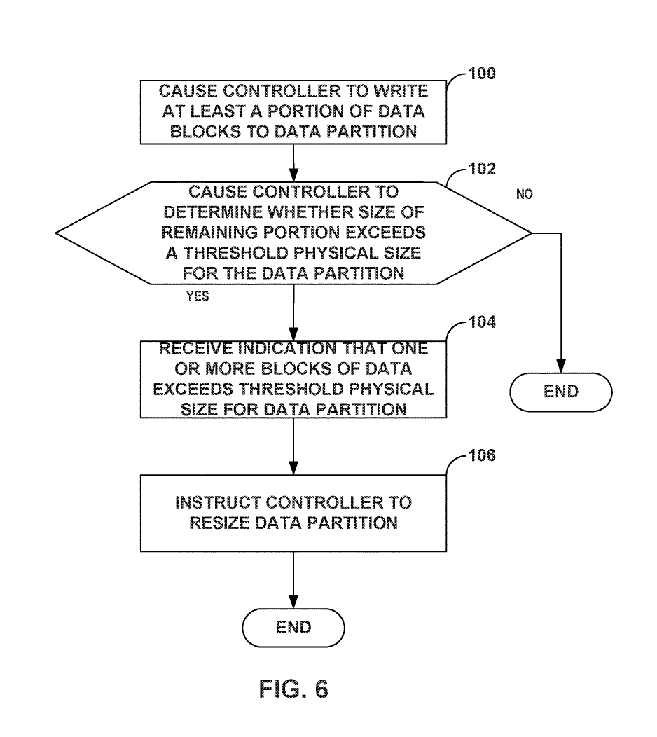

FIG. 6 is a flow diagram illustrating a technique performed by a host device for determining whether one or more blocks of data exceeds the threshold physical size for the data partition, in accordance with one or more techniques of this disclosure. For the purposes of illustration only, reference will be made to structures of FIG. 1 in describing the functionality performed in accordance with the techniques of this disclosure.

In some examples, host device 4 may cause controller 8 to write at least a portion of one or more blocks of data to the data partition of storage device 6 (100). Host device 4 may then cause controller 8 to determine whether a size of a remaining portion of the one or more blocks of data to be written to the data partition exceeds a threshold physical size for the data partition (102). If the size of the remaining portion does not exceed the physical threshold (NO branch of 102), controller 8 may continue to write the remaining portion of the blocks of data to the data partition. On the other hand, responsive to the size of the remaining portion of the one or more blocks of data exceeding the threshold physical size for the data partition (YES branch of 102), host device 4 may receive an indication that the one or more blocks of data exceeds the threshold physical size for the data partition (104). For instance, the threshold physical size for the data partition may be a difference between the allocated physical capacity of the data partition and an amount of physical space used by the portion of the one or more blocks of data. In other words, controller 8 may, responsive to commands from host device 4, dynamically check if the data to be written to the data partition will be too large for the data partition based on the currently available physical space. This could occur if the compression ratio is less than the assumed compression ratio, such as 1.5:1 instead of 2:1. Rather than simply attempt to write all of the one or more data blocks to the data partition and deal with errors should they arise, by dynamically checking the available space and comparing the available space with the remaining data to be written, controller 8 may resize the data partition before such errors are realized.

In some examples, in response to receiving the indication that the one or more blocks of data exceeds the threshold physical size for the data partition (104), host device 4 may perform one or more actions (106). For example host device 4 may instruct controller 8 to resize the data partition to a larger allocated physical capacity so the one or more blocks of data can be stored by the data partition.

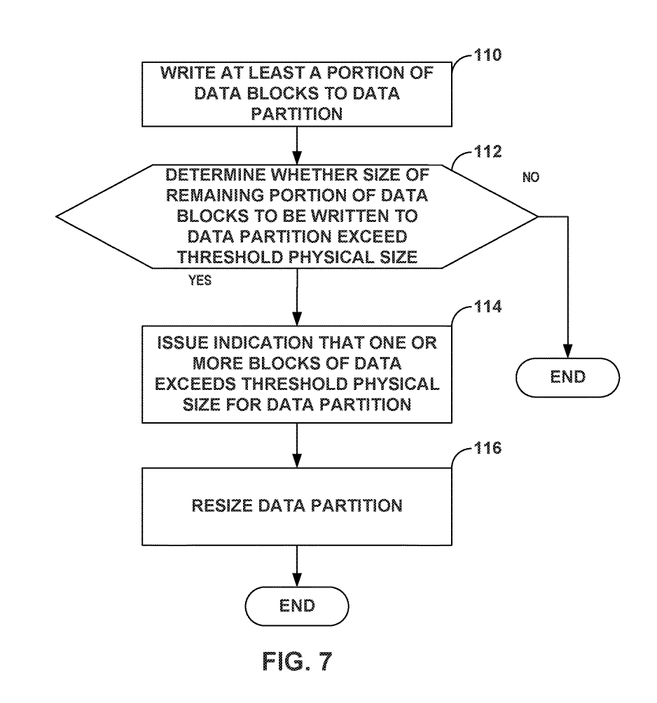

FIG. 7 is a flow diagram illustrating a technique performed by a controller of a storage device for determining whether one or more blocks of data exceeds the threshold physical size for the data partition, in accordance with one or more techniques of this disclosure. For the purposes of illustration only, reference will be made to structures of FIG. 1 in describing the functionality performed in accordance with the techniques of this disclosure.

In some examples, controller 8 may write at least a portion of the one or more blocks of data to the data partition of storage device 6 (110). Controller 8 may then determine whether a size of a remaining portion of the one or more blocks of data to be written to the data partition exceeds a threshold physical size for the data partition (112). If the size of the remaining portion does not exceed the physical threshold (NO branch of 112), controller 8 may continue to write the remaining portion of the blocks of data to the data partition. On the other hand, responsive to the size of the remaining portion of the one or more blocks of data exceeding the threshold physical size for the data partition (YES branch of 112), controller 8 may issue an indication that the one or more blocks of data exceeds the threshold physical size for the data partition (114). For instance, the threshold physical size for the data partition may be a difference between the allocated physical capacity of the data partition and an amount of physical space used by the portion of the one or more blocks of data. In other words, controller 8 may, responsive to commands from host device 4, dynamically check if the data to be written to the data partition will be too large for the data partition based on the currently available physical space. This could occur if the compression ratio is less than the assumed compression ratio, such as 1.5:1 instead of 2:1. Rather than simply attempt to write all of the one or more data blocks to the data partition and deal with errors should they arise, by dynamically checking the available space and comparing the available space with the remaining data to be written, controller 8 may resize the data partition before such errors are realized.

In some examples, in response to issuing the indication that the one or more blocks of data exceeds the threshold physical size for the data partition (114), controller 8 may perform one or more actions (116). For example controller 8 may resize the data partition to a larger allocated physical capacity so the one or more blocks of data can be stored by the data partition.

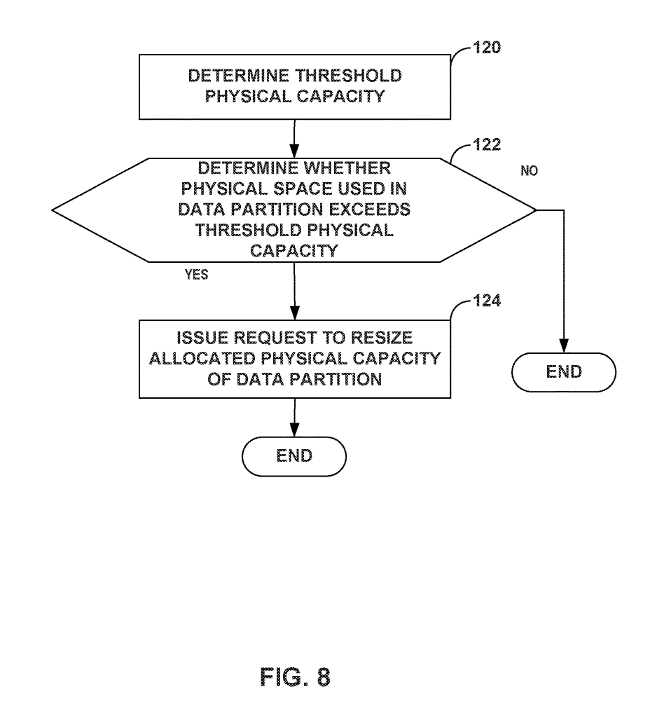

FIG. 8 is a flow diagram illustrating a determination to resize a data partition performed by either a host device or a controller of a storage device, in accordance with one or more techniques of this disclosure. For the purposes of illustration only, reference will be made to structures of FIG. 1 in describing the functionality performed in accordance with the techniques of this disclosure.

In some examples where host device 4 performs the technique, host device 4 may determine a threshold physical capacity based on the allocated physical capacity for the data partition (120), such as 90% of the total allocated physical capacity, or the like. In such examples, host device 4 may then determine that the physical space used in the data partition exceeds the threshold physical capacity (122). When the physical space used exceeds the threshold physical capacity (YES branch of 122), host device 4 may issue a request to resize the allocated physical capacity of the data partition to controller 8 (124). Otherwise (NO branch of 122), host device 4 may continue with other operations.

In other examples where controller 8 performs the technique, controller 8 may determine a threshold physical capacity based on the allocated physical capacity for the data partition (120), such as 90% of the total allocated physical capacity, or the like. In such examples, controller 8 may then determine that the physical space used in the data partition exceeds the threshold physical capacity (122). When the physical space used exceeds the threshold physical capacity (YES branch of 122), controller 8 may issue a request to resize the allocated physical capacity of the data partition to host device 4 (124). Otherwise (NO branch of 122), controller 8 may continue with other operations.

### Example 1

A method comprising: causing, by a host device, a controller of a data storage device to create a data partition in the data storage device based on a maximum exposed logical size for the data partition, a maximum allocated logical capacity for the data partition, and an allocated physical capacity for the data partition; causing, by the host device, the controller to write one or more blocks of data to the data partition; and receiving, by the host device, from the controller, an indication representative of physical space used in the data partition based on the written one or more blocks of data.

### Example 2

The method of example 1, further comprising: determining, by the host device, a usage percentage of the data partition based on the allocated physical capacity and the indication representative of physical space in the data partition.

### Example 3

The method of example 2, further comprising: determining, by the host device, a compression ratio of the data partition based on the amount of physical space used by the one or more blocks of data and an amount of logical capacity used by the one or more blocks of data.

### Example 4

The method of example 3, further comprising: causing, by the host device, the controller to resize the allocated physical capacity of the data partition based on the usage percentage and the compression ratio.

### Example 5

The method of example 3, further comprising: causing, by the host device, the controller to resize at least one of the maximum exposed logical size or the maximum allocated logical capacity based on the usage percentage and the compression ratio.

### Example 6

The method of any of examples 1-5, wherein the data partition is an NVMe namespace or an SAS logical unit.

### Example 7

The method of any of examples 1-6, wherein causing the controller to write the one or more blocks of data comprises: causing, by the host device, the controller to write at least a portion of the one or more blocks of data to the data partition of the data storage device; causing, by the host device, the controller to determine whether a size of a remaining portion of the one or more blocks of data to be written to the data partition of the storage device exceeds a threshold physical size for the data partition; and responsive to determining that the size of the remaining portion of the one or more blocks of data to be written to the data partition of the storage device exceeds the threshold physical size for the data partition, receiving, by the host device, an indication that the one or more blocks of data exceeds the threshold physical size for the data partition.

### Example 8

The method of example 7, wherein the threshold physical size for the data partition comprises a difference between the allocated physical capacity of the data partition and an amount of physical space used by the portion of the one or more blocks of data.

### Example 9

The method of example 7, further comprising: responsive to receiving the indication that the one or more blocks of data exceeds the threshold physical size for the data partition, causing, by the host device, based on the size of the remaining portion of the one or more data blocks, the controller to resize the data partition.

### Example 10

The method of any of examples 1-9, further comprising: determining, by the host device, a threshold physical capacity based on the allocated physical capacity for the data partition; determining, by the host device, based on the indication representative of physical space used in the data partition, that the physical space used in the data partition exceeds the threshold physical capacity; and issuing, by the host device, a request to resize the allocated physical capacity of the data partition to the controller.

### Example 11

A method comprising: creating, by a controller of a storage device, a data partition in the data storage device based on a maximum exposed logical size for the data partition, a maximum allocated logical capacity for the data partition, and an allocated physical capacity for the data partition; writing, by the controller, one or more blocks of data to the data partition; and sending, by the controller, an indication representative of physical space used in the data partition to a host device based on the written one or more blocks of data.

### Example 12

The method of example 10, further comprising: determining, by the controller, a usage percentage of the data partition based on the allocated physical capacity and the indication representative of physical space in the data partition.

### Example 13

The method of example 11, further comprising: determining, by the controller, a compression ratio of the data partition based on the amount of physical space used by the one or more blocks of data and an amount of logical capacity used by the one or more blocks of data.

### Example 14

The method of example 13, further comprising: resizing, by the controller, the allocated physical capacity of the data partition based on the usage percentage and the compression ratio.

### Example 15

The method of example 13, further comprising: resizing, by the controller, at least one of the maximum exposed logical size or the maximum allocated logical capacity based on the usage percentage and the compression ratio.

### Example 16

The method of any of examples 10-14, wherein the data partition is an NVMe namespace or an SAS logical unit.

### Example 17

The method of any of examples 10-15, wherein writing the one or more blocks of data comprises: writing, by the controller, at least a portion of the one or more blocks of data to the data partition of the data storage device; determining, by the controller, whether a size of a remaining portion of the one or more blocks of data to be written to the data partition of the storage device exceeds a threshold physical size for the data partition; and responsive to determining that the size of the remaining portion of the one or more blocks of data to be written to the data partition of the storage device exceeds the threshold physical size for the data partition, issuing, by the controller, an indication that the one or more blocks of data exceeds the threshold physical size for the data partition.

### Example 18

The method of example 16, wherein the threshold physical size for the data partition comprises a difference between the allocated physical capacity of the data partition and an amount of physical space used by the portion of the one or more blocks of data.

### Example 19

The method of example 17, further comprising: responsive to issuing the indication that the one or more blocks of data exceeds the threshold physical size for the data partition, resizing, by the controller, based on the size of the remaining portion of the one or more data blocks, the data partition.

### Example 20

The method of any of examples 10-17, further comprising: determining, by the controller, a threshold physical capacity based on the allocated physical capacity for the data partition; determining, by the controller, based on the indication representative of physical space used in the data partition, that the physical space used in the data partition exceeds the threshold physical capacity; and issuing, by the controller, a request to resize the allocated physical capacity of the data partition to the host device.

### Example 21

A host device configured to perform the method of any of claims 1-10.

### Example 22

A controller of a storage device configured to perform the method of any of claims 11-20.

### Example 23

A device comprising means for performing the method of any of claims 1-20.

### Example 24

A computer-readable storage medium encoded with instructions that, when executed, cause one or more processors to perform the method of any of claims 1-20.

### Example 25

A host device comprising one or more processors configured to: cause a controller of a data storage device to create a data partition in the data storage device based on a maximum exposed logical size for the data partition, a maximum allocated logical capacity for the data partition, and an allocated physical capacity for the data partition; cause the controller to write one or more blocks of data to the data partition; and receive, from the controller, an indication representative of physical space used in the data partition based on the written one or more blocks of data.

### Example 26

The host device of example 25, wherein the one or more processors are further configured to: determine a usage percentage of the data partition based on the allocated physical capacity and the indication representative of physical space in the data partition; determine a compression ratio of the data partition based on the amount of physical space used by the one or more blocks of data and an amount of logical capacity used by the one or more blocks of data; cause the controller to resize the allocated physical capacity of the data partition based on the usage percentage and the compression ratio; and cause the controller to resize at least one of the maximum exposed logical size or the maximum allocated logical capacity based on the usage percentage and the compression ratio.

### Example 27

The host device of any of examples 25-26, wherein the one or more processors being configured to cause the controller to write the one or more blocks of data comprises the one or more processors being configured to: cause the controller to write at least a portion of the one or more blocks of data to the data partition of the data storage device; cause the controller to determine whether a size of a remaining portion of the one or more blocks of data to be written to the data partition of the storage device exceeds a threshold physical size for the data partition; responsive to determining that the size of the remaining portion of the one or more blocks of data to be written to the data partition of the storage device exceeds the threshold physical size for the data partition, receive an indication that the one or more blocks of data exceeds the threshold physical size for the data partition; and responsive to receiving the indication that the one or more blocks of data exceeds the threshold physical size for the data partition, cause, based on the size of the remaining portion of the one or more data blocks, the controller to resize the data partition, wherein the threshold physical size for the data partition comprises a difference between the allocated physical capacity of the data partition and an amount of physical space used by the portion of the one or more blocks of data.

### Example 28

The host device of any of examples 25-27, wherein the one or more processors are further configured to: determine a threshold physical capacity based on the allocated physical capacity for the data partition; determine based on the indication representative of physical space used in the data partition, that the physical space used in the data partition exceeds the threshold physical capacity; and issue a request to resize the allocated physical capacity of the data partition to the controller.

### Example 29

A storage device comprising a controller configured to: create a data partition in the data storage device based on a maximum exposed logical size for the data partition, a maximum allocated logical capacity for the data partition, and an allocated physical capacity for the data partition; write one or more blocks of data to the data partition; and send an indication representative of physical space used in the data partition to a host device based on the written one or more blocks of data.

### Example 30

The storage device of example 29, wherein the controller is further configured to: determine a usage percentage of the data partition based on the allocated physical capacity and the indication representative of physical space in the data partition; determine a compression ratio of the data partition based on the amount of physical space used by the one or more blocks of data and an amount of logical capacity used by the one or more blocks of data; resize the allocated physical capacity of the data partition based on the usage percentage and the compression ratio; and resize at least one of the maximum exposed logical size or the maximum allocated logical capacity based on the usage percentage and the compression ratio.

### Example 31

The storage device of any of examples 29-30, wherein the controller being configured to write the one or more blocks of data comprises the controller being configured to: write at least a portion of the one or more blocks of data to the data partition of the data storage device; determine whether a size of a remaining portion of the one or more blocks of data to be written to the data partition of the storage device exceeds a threshold physical size for the data partition; responsive to determining that the size of the remaining portion of the one or more blocks of data to be written to the data partition of the storage device exceeds the threshold physical size for the data partition, issue an indication that the one or more blocks of data exceeds the threshold physical size for the data partition; and responsive to issuing the indication that the one or more blocks of data exceeds the threshold physical size for the data partition, resize based on the size of the remaining portion of the one or more data blocks, the data partition, wherein the threshold physical size for the data partition comprises a difference between the allocated physical capacity of the data partition and an amount of physical space used by the portion of the one or more blocks of data.

### Example 32

The storage device of any of examples 29-31, wherein the controller is further configured to: determine a threshold physical capacity based on the allocated physical capacity for the data partition; determine based on the indication representative of physical space used in the data partition, that the physical space used in the data partition exceeds the threshold physical capacity; and issue a request to resize the allocated physical capacity of the data partition to the host device.

The techniques described in this disclosure may be implemented, at least in part, in hardware, software, firmware, or any combination thereof For example, various aspects of the described techniques may be implemented within one or more processing units, including one or more microprocessing units, digital signal processing units (DSPs), application specific integrated circuits (ASICs), field programmable gate arrays (FPGAs), or any other equivalent integrated or discrete logic circuitry, as well as any combinations of such components. The term “processing unit” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processing units, or other processing units, to implement one or more of the techniques described herein, such as when instructions included or encoded in the computer-readable storage medium are executed by the one or more processing units. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disk ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples of the disclosure have been described. Any combination of the described systems, operations, or functions is contemplated. These and other examples are within the scope of the following claims.

1. A method comprising:
causing, by a host device, a controller of a data storage device to create a data partition in the data storage device based on a maximum exposed logical size for the data partition, a maximum allocated logical capacity for the data partition, and an allocated physical capacity for the data partition;
causing, by the host device, the controller to write one or more blocks of data to the data partition; and
receiving, by the host device, from the controller, an indication representative of physical space used in the data partition based on the written one or more blocks of data.

2. The method of claim 1, further comprising:
determining, by the host device, a usage percentage of the data partition based on the allocated physical capacity and the indication representative of physical space in the data partition; and
determining, by the host device, a compression ratio of the data partition based on the amount of physical space used by the one or more blocks of data and an amount of logical capacity used by the one or more blocks of data.

3. The method of claim 2, further comprising:
causing, by the host device, the controller to resize the allocated physical capacity of the data partition based on the usage percentage and the compression ratio.

4. The method of claim 2, further comprising:
causing, by the host device, the controller to resize at least one of the maximum exposed logical size or the maximum allocated logical capacity based on the usage percentage and the compression ratio.

5. The method of claim 1, wherein the data partition is an NVMe namespace or an SAS logical unit.

6. The method of claim 1, wherein causing the controller to write the one or more blocks of data comprises:
causing, by the host device, the controller to write at least a portion of the one or more blocks of data to the data partition of the data storage device;
causing, by the host device, the controller to determine whether a size of a remaining portion of the one or more blocks of data to be written to the data partition of the storage device exceeds a threshold physical size for the data partition; and
responsive to determining that the size of the remaining portion of the one or more blocks of data to be written to the data partition of the storage device exceeds the threshold physical size for the data partition, receiving, by the host device, an indication that the one or more blocks of data exceeds the threshold physical size for the data partition,
wherein the threshold physical size for the data partition comprises a difference between the allocated physical capacity of the data partition and an amount of physical space used by the portion of the one or more blocks of data.

7. The method of claim 6, further comprising:
responsive to receiving the indication that the one or more blocks of data. exceeds the threshold physical size for the data partition, causing, by the host device, based on the size of the remaining portion of the one or more data blocks, the controller to resize the data partition.

8. The method of claim 1, further comprising:
determining, by the host device, a threshold physical capacity based on e allocated physical capacity for the data partition;
determining, by the host device, based on the indication representative of physical space used in the data partition, that the physical space used in the data partition exceeds the threshold physical capacity; and
issuing, by the host device, a request to resize the allocated physical capacity of the data partition to the controller.

9. A method comprising:
creating, by a controller of a storage device, a data partition in the data storage device based on a maximum exposed logical size for the data partition, a maximum allocated logical capacity for the data partition, and an allocated physical capacity for the data partition;
writing, by the controller, one or more blocks of data to the data partition; and
sending, by the controller, an indication representative of physical space used in the data partition to a host device based on the written one or more blocks of data.

10. The method of claim 9, further comprising:
determining, by the controller, a usage percentage of the data partition based on the allocated physical capacity and the indication representative of physical space in the data partition; and
determining, by the controller, a compression ratio of the data partition based on the amount of physical space used by the one or more blocks of data and an amount of logical capacity used by the one or more blocks of data.

11. The method of claim 10, further comprising:
resizing, by the controller, the allocated physical capacity of the data partition based on the usage percentage and the compression ratio.

12. The method of claim 10, further comprising:
resizing, by the controller, at least one of the maximum exposed logical size or the maximum allocated logical capacity based on the usage percentage and the compression ratio.

13. The method of claim 10, wherein the data partition is an NVMe namespace or an SAS logical unit.

14. The method of claim 9, wherein writing the one or more blocks of data comprises:
writing, by the controller, at least a portion of the one or more blocks of data to the data partition of the data storage device;
determining, by the controller, whether a size of a remaining portion of the one or more blocks of data to be written to the data partition of the storage device exceeds a threshold physical size for the data partition; and
responsive to determining that the size of the remaining portion of the one or more blocks of data to be written to the data partition of the storage device exceeds the threshold physical size for the data partition, issuing, by the controller, an indication that the one or more blocks of data exceeds the threshold physical size for the data partition,
wherein the threshold physical size for the data partition comprises a difference between the allocated physical capacity of the data partition and an amount of physical space used by the portion of the one or more blocks of data.

15. The method of claim 14, further comprising:
responsive to issuing the indication that the one or more blocks of data exceeds the threshold physical size for the data partition, resizing, by the controller, based on the size of the remaining portion of the one or more data blocks, the data partition.

16. The method of claim 9, further comprising:
determining, by the controller, a threshold physical capacity based on the allocated physical capacity for the data partition;
determining, by the controller, based on the indication representative of physical space used in the data partition, that the physical space used in the data partition exceeds the threshold physical capacity; and
issuing, by the controller, a request to resize the allocated physical capacity of the data partition to the host device.

17. A host device comprising one or more processors configured to:
cause a controller of a data storage device to create a data partition in the data storage device based on a maximum exposed logical size for the data partition, a maximum allocated logical capacity for the data partition, and an allocated physical capacity for the data partition;
cause the controller to write one or more blocks of data to the data partition; and
receive, from the controller, an indication representative of physical space used in the data partition based on the written one or more blocks of data.

18. The host device of claim 17, wherein the one or more processors are further configured to:
determine a usage percentage of the data partition based on the allocated physical capacity and the indication representative of physical space in the data partition;
determine a compression ratio of the data partition based on the amount of physical space used by the one or more blocks of data and an amount of logical capacity used by the one or more blocks of data;
cause the controller to resize the allocated physical capacity of the data partition based on the usage percentage and the compression ratio; and
cause the controller to resize at least one of the maximum exposed logical size or the maximum allocated logical capacity based on the usage percentage and the compression ratio.

19. The host device of claim 17, wherein the one or more processors being configured to cause the controller to write the one or more blocks of data comprises the One or more processors being configured to:
cause the controller to write at least a portion of the one or more blocks of data. to the data partition of the data storage device;
cause the controller to determine whether a size of a remaining portion of the one or more blocks of data to be written to the data partition of the storage device exceeds a threshold physical size for the data partition;
responsive to determining that the size of the remaining portion of the one or more blocks of data to he written to the data partition of the storage device exceeds the threshold physical size for the data partition, receive an indication that the one or more blocks of data exceeds the threshold physical size for the data partition; and
responsive to receiving the indication that the one or more blocks of data exceeds the threshold physical size for the data partition, cause, based on the size of the remaining portion of the one or more data blocks, the controller to resize the data partition,
wherein the threshold physical size for the data partition comprises a difference between the allocated physical capacity of the data partition and an amount of physical space used by the portion of the one or more blocks of data.

20. The host device of claim 17, wherein the one or more processors are further configured to:
determine a threshold physical capacity based on the allocated physical capacity for the data partition;
determine based on the indication representative of physical space used in the data partition, that the physical space used in the data partition exceeds the threshold physical capacity; and
issue a request to resize the allocated physical capacity of the data partition to the controller.

21. A storage device comprising a controller configured to:
create a data partition in the data storage device based on a maximum exposed logical size for the data partition, a maximum allocated logical capacity for the data partition, and an allocated physical capacity for the data partition;
write one or more blocks of data to the data partition; and
send an indication representative of physical space used in the data partition to a host device based on the written one or more blocks of data.

22. The storage device of claim 21, wherein the controller is further configured to:
determine a usage percentage of the data partition based on the allocated physical capacity and the indication representative of physical space in the data partition;
determine a compression ratio of the data partition based on the amount of physical space used by the one or more blocks of data and an amount of logical capacity used by the one or more blocks of data;
resize the allocated physical capacity of the data partition based on the usage percentage and the compression ratio; and
resize at least one of the maximum exposed logical size or the maximum allocated logical capacity based on the usage percentage and the compression ratio.

23. The storage device of claim 21, wherein the controller being configured to write the one or more blocks of data comprises the controller being configured to:
write at least a portion of the one or more blocks of data to the data partition of the data storage device;
determine whether a size of a remaining portion of the one or more blocks of data to be written to the data partition of the storage device exceeds a threshold physical size for the data partition;
responsive to determining that the size of the remaining portion of the one or more blocks of data to be written to the data partition of the storage device exceeds the threshold physical size for the data partition, issue an indication that the one or more blocks of data exceeds the threshold physical size for the data partition; and
responsive to issuing the indication that the one or more blocks of data exceeds the threshold physical size for the data partition, resize based on the size of the remaining portion of the one or more data blocks, the data partition,
Wherein the threshold physical size for the data partition comprises a difference between the allocated physical capacity of the data partition and an amount of physical space used by the portion of the one or more blocks of data.

24. The storage device of claim 21, wherein the controller is further configured to:
determine a threshold physical capacity based on the allocated physical capacity for the data partition;
determine based on the indication representative of physical space used in the data partition, that the physical space used in the data partition exceeds the threshold physical capacity; and
issue a request to resize the allocated physical capacity of the data partition to the host device.
